(19) United States
(12) Patent Application Publication
(10) Pub. No.: US 2026/0234888 A1
(43) Pub. Date: Aug. 13, 2026

(54) CONE PENETROMETER TEST FRAMEWORK

(71) Applicant: SCHLUMBERGER TECHNOLOGY CORPORATION, Sugar Land, TX (US)

(72) Inventors: Vanessa da Silva Simoes, Houston, TX (US); Aria Abubakar, Houston, TX (US); Haibin Di, Houston, TX (US); Hiren Maniar, Houston, TX (US)

(21) Appl. No.: 19/153,617

(22) PCT Filed: Mar. 26, 2024
(86) PCT No.: PCT/US2024/021444

§ 371 Date: Aug. 5, 2025

Related U.S. Application Data
(60) Provisional application No. 63/454,698, filed on Mar. 26, 2023.

(51) Int. Cl. E02D 1/02; G06N 3/0464

(52) U.S. Cl. CPC E02D 1/02; G06N 3/0464

(57) ABSTRACT

A method can include receiving cone penetrometer test data of measurements referenced with respect to depth in stratified material for a location at a site; processing the cone penetrometer test data using a machine learning model-based computational framework to identify one or more quality issues and to generate synthetic cone penetrometer test data at one or more depths; and outputting improved quality cone penetrometer data based at least in part on the generated synthetic cone penetrometer test data.

### RELATED APPLICATION

This application claims priority to and the benefit of a U.S. Provisional Application having Ser. No. 63/454,698, filed 26 Mar. 2023, which is incorporated by reference herein in its entirety.

### BACKGROUND

A cone penetrometer (or penetration) test (CPT) is a method used to determine the geotechnical engineering properties of material (e.g., soils) and, for example, delineating stratigraphy. Such tests can be performed to characterize a site where the tests are performed at various locations at a site. For various reasons, CPT data can be lacking in quality, which can confound site analysis. Addressing quality tends to be a tedious, manual process that involves substantial time where it can be difficult to resolve issues that may exist in a single CPT log or in multiple CPT logs. As described herein, a framework can improve quality of CPT data and, for example, generate output relevant for design, construction, etc., of one or more types of foundations for energy production equipment support and operation.

### SUMMARY

A method can include receiving cone penetrometer test data of measurements referenced with respect to depth in stratified material for a location at a site; processing the cone penetrometer test data using a machine learning model-based computational framework to identify one or more quality issues and to generate synthetic cone penetrometer test data at one or more depths; and outputting improved quality cone penetrometer data based at least in part on the generated synthetic cone penetrometer test data.

A system can include a processor; a memory accessible to the processor; processor-executable instructions stored in the memory and executable by the processor to instruct the system to: receive cone penetrometer test data of measurements referenced with respect to depth in stratified material for a location at a site; process the cone penetrometer test data using a machine learning model-based computational framework to identify one or more quality issues and to generate synthetic cone penetrometer test data at one or more depths; and output improved quality cone penetrometer data based at least in part on the generated synthetic cone penetrometer test data.

One or more computer-readable media can include computer-executable instructions executable by a system to instruct the system to: receive cone penetrometer test data of measurements referenced with respect to depth in stratified material for a location at a site; process the cone penetrometer test data using a machine learning model-based computational framework to identify one or more quality issues and to generate synthetic cone penetrometer test data at one or more depths; and output improved quality cone penetrometer data based at least in part on the generated synthetic cone penetrometer test data.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates examples of systems;

FIG. 2 illustrates an example of a method;

FIG. 3 illustrates an example of a system;

FIG. 4 illustrates an example of a system;

FIG. 5 illustrates an example of a CPT instrument;

FIG. 6 illustrates an example of a CPT instrument;

FIG. 7 illustrates an example of a site with CPT locations;

FIG. 8 illustrates an example of a CPT log;

FIG. 9 illustrates examples of CPT logs from different entities;

FIG. 10 illustrates an example of a CPT log;

FIG. 11 illustrates an example of a workflow;

FIG. 12 illustrates an example of a machine learning model architecture;

FIG. 13 illustrates an example of a cross-plot;

FIG. 14 illustrates examples of cross-plots;

FIG. 15 illustrates examples of cross-plots;

FIG. 16 illustrates an example of a CPT log;

FIG. 17 illustrates an example of a CPT log with input and machine learning model-based output;

FIG. 18 illustrates an example of a model;

FIG. 19 illustrates an example of a graphical user interface that includes examples of model input, measured and/or derived data, and model output;

FIG. 20 illustrates an example of a graphical user interface that includes examples of model input, measured and/or derived data, and model output;

FIG. 21 illustrates an example of a graphical user interface that includes examples of model input, measured and/or derived data, and model output;

FIG. 22 illustrates an example of a method and an example of a system; and

FIG. 23 illustrates examples of computer and network equipment.

### DETAILED DESCRIPTION

This description is not to be taken in a limiting sense, but rather is made merely for the purpose of describing the general principles of the implementations. The scope of the described implementations should be ascertained with reference to the issued claims.

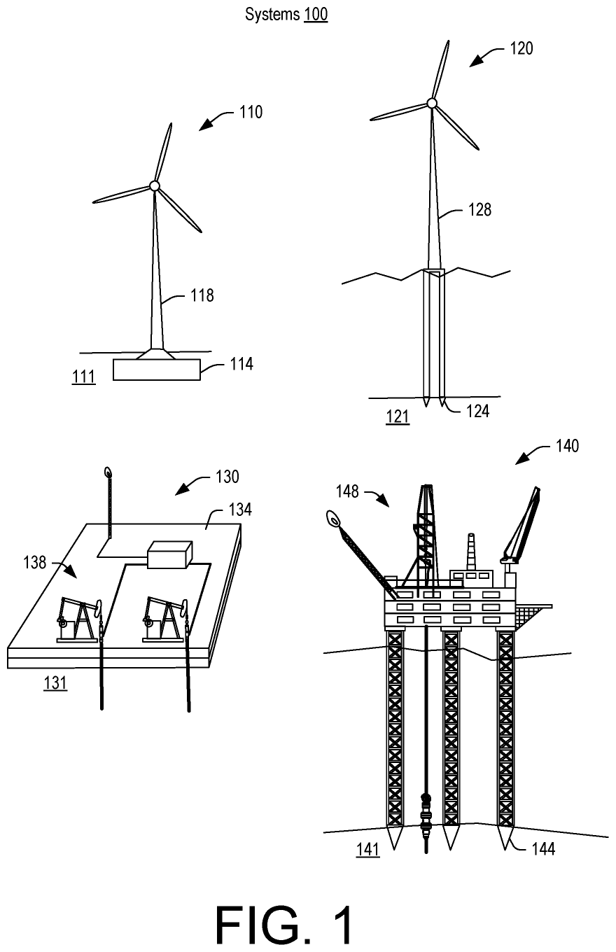

FIG. 1 shows examples of systems 100, including a land wind energy production system 110, a marine wind energy production system 120, a land fluid energy production system 130, and a marine fluid energy production system 140. As shown, each of the systems 110, 120, 130, and 140 is built on material 111, 121, 131, and 141, respectively, using a foundation 114, 124, 134, and 144, respectively, to support system equipment 118, 128, 138, and 148, respectively.

The systems 100 can be constructed according to plans that are based on data, which can include field data as to the material 111, 121, 131, and 141, for example, to appropriately design and build the foundations 114, 124, 134, and 144. For example, a cone penetrometer (or penetration) test (CPT) can be performed to characterize the material 111, 121, 131, and 141.

CPT is a method used to determine geotechnical engineering properties of material (e.g., soils) and, for example, delineating stratigraphy. A CPT can involve pushing an instrumented cone, with its tip facing down, into material at a controlled rate (e.g., consider a speed of approximately 0.5 cm/s to approximately 5 cm/s). Resolution of a CPT in delineating stratigraphic layers is related to the size of the cone tip, which may be defined in part by its cross-sectional area (e.g., from approximately 1 cm² to approximately 30 cm². CPT for geotechnical applications was standardized in 1986 by ASTM Standard D 3441 (ASTM, 2004). Later ASTM Standards have addressed the use of CPT for various environmental site characterization and groundwater monitoring activities.

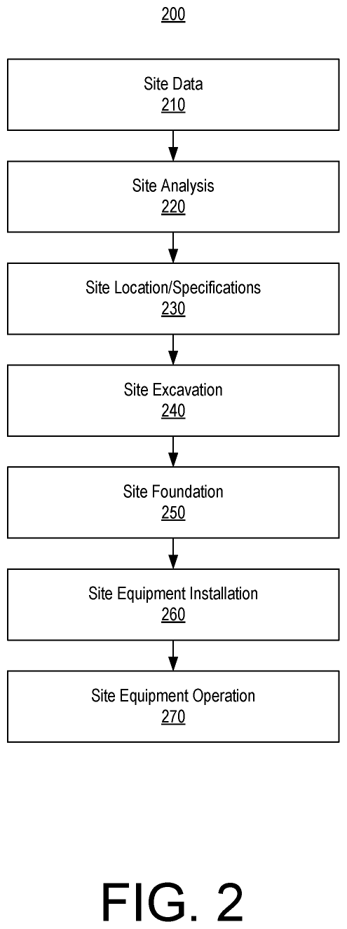

FIG. 2 shows an example of a method 200 that includes a site data block 210 for acquiring site data, a site analysis block 220 for analyzing a site based on data, a site location/specifications block 230 for determining a location and specifications for a foundation for equipment at a site, a site excavation block 240 for excavating a site for installation of a foundation, a site foundation block 250 for installing a foundation for the equipment at the site, a site equipment installation block 260 for installing the equipment supported by the foundation at the site, and a site equipment operation block 270 for operating the equipment at the site as supported by the foundation.

As shown in FIG. 1, the equipment 118 can include a wind turbine on a shaft supported by the foundation 114, the equipment 128 can include a marine wind turbine on a shaft supported by the foundation 124, the equipment 138 can include surface equipment to produce and/or handle fluid as supported by the foundation 134 (e.g., a pad or pads), and the equipment 148 can include offshore equipment as supported by the foundation 144. In various instances, a foundation can include discrete portions or may be a monolithic structure. Safe and effective operation of equipment can depend on safe and effective support. In various industrial energy operations, whether onshore and/or offshore, foundation design and construction is imperative.

As to wind turbine equipment, blade length or rotor diameter can be a factor as to power generating capacity, forces and hub height from a ground surface or a water surface. For example, a 6 MW wind turbine may have a rotor diameter of approximately 150 m and a hub height of approximately 100 m. A foundation type may be selected for a wind turbine based on a variety of factors, which, as explained, can include characteristics of subsurface material. Foundations types may include, for example, monopile, monopod, jacket on piles, jacket on bucket, etc. As an example, an offshore wind monopile may be tens of meters in length (e.g., 10 m, 20 m, 30 m, etc.) and more than a meter in diameter (e.g., 4 m, 6 m, etc.) where a length to diameter ratio may be in a range of approximately 3 to 10 (e.g., consider 5 to 7, etc.). As to loading on a wind turbine, in addition to wind, for offshore equipment, water waves may be taken into account; noting that loading may be cyclic (see, e.g., Lunne, 2016).

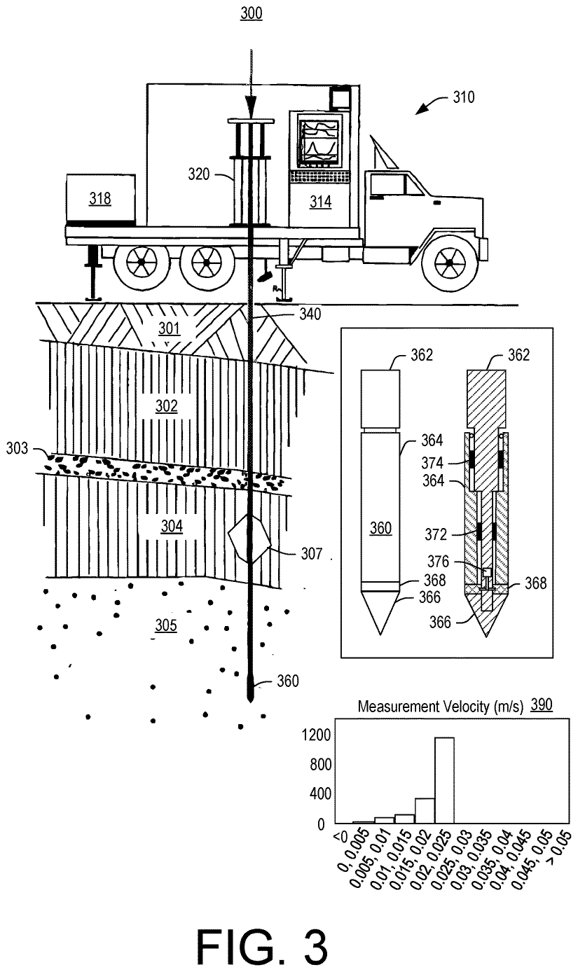

FIG. 3 shows an example of a system 300 that includes a vehicle 310 supported on stratified material, with material layers 301, 302, 303, 304, and 305, which may include one or more anomalies such as, for example, a void 307. As shown, the vehicle 310 can be equipped to perform a CPT at a location. For example, the vehicle 310 can include computerized equipment 314, cleaning equipment 318, and a hydraulic driver 320 to drive a shaft 340 into the stratified material where a CPT instrument 360 is attached to a distal end of the shaft 340. As shown, the hydraulic driver 320, which may be controlled by the computerized equipment 314, can apply force to move the CPT instrument 360 into the stratified material at a relatively constant rate, which can be referred to as measurement velocity. FIG. 3 shows an example of a plot 390 of a measurement velocity distribution, which indicates that a maximum velocity may be controlled and where some velocities can be less than the maximum velocity, for example, due to contact between the shaft 340 and/or the CPT instrument 360 and the stratified material. In the plot 390, the measurement velocity is given in units of meters per second, with a maximum of approximately 0.025 meters per second (m/s), where during a CPT, the measurement velocity is predominantly between 0.02 m/s and 0.025 m/s. In general, velocity is well-behaved and near between 0.01 m/s and 0.03 m/s for most of the depths in field example with recorded time.

FIG. 3 also shows a side view and an approximate cross-sectional view of the CPT instrument 360, which can include an inner shaft 362, an outer shaft 364, a cone 366, a porous material 368, a first load sensor 372, a second load sensor 374 and a fluid pressure sensor 376. As shown, the inner shaft 362 can extend an axial distance into a bore of the outer shaft 364. In such an approach, some amount of movement is possible, which can be measured using one or more of the first load sensor 372 and the second load sensor 374. The CPT instrument 360 can be operatively coupled to the computerized equipment 314 such that data can be acquired during a CPT.

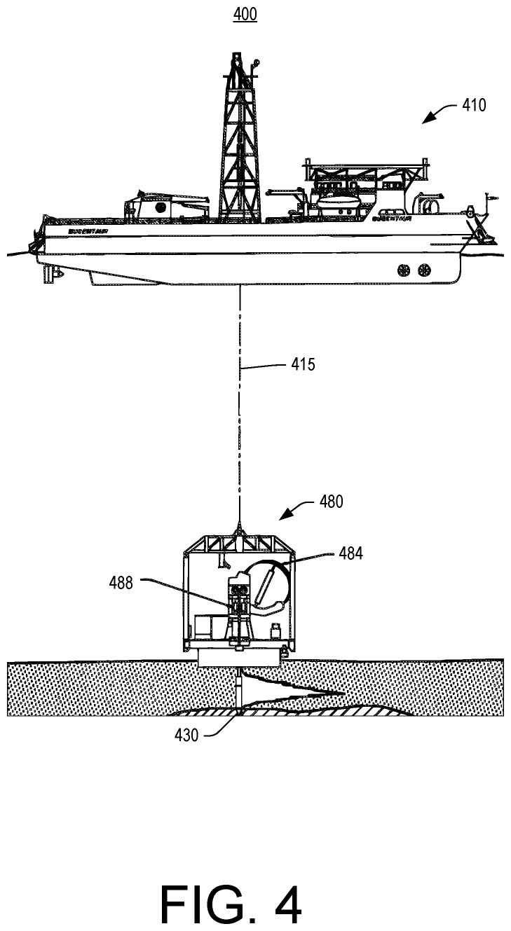

FIG. 4 shows example of a system 400 that includes a vessel 410, a lift line and umbilical 415, and a seabed CPT assembly 480 that includes a coil 484 and a motor 488 (e.g., a belt drive assembly) to drive the coil 484 into stratified material where a CPT instrument 430 is attached to an end of the coil 484.

As an example, the system 300 of FIG. 3 can be utilized for the systems 110 and 130 of FIG. 1 and the system 400 of FIG. 4 can be utilized for the systems 120 and 140 of FIG. 1. For example, consider use of the system 300 or the system 400 in a method such as the method 200 of FIG. 2.

Various types of measurements can be acquired using a CPT instrument to output values, which may be direct or derived. For example, consider QT (or qₜ), which is total cone resistance; FRES (or fₛ or fs), which is sleeve friction (e.g., shaft or rod friction); u₂, which is penetration pore pressure at a shoulder of the cone; and normalized dimensionless derived values that can include FRR, as a friction ratio, and BQ (or Bq), as a normalized pore pressure ratio or pore pressure ratio. Another measurement is u₁, which is pore pressure if measured on a cone face.

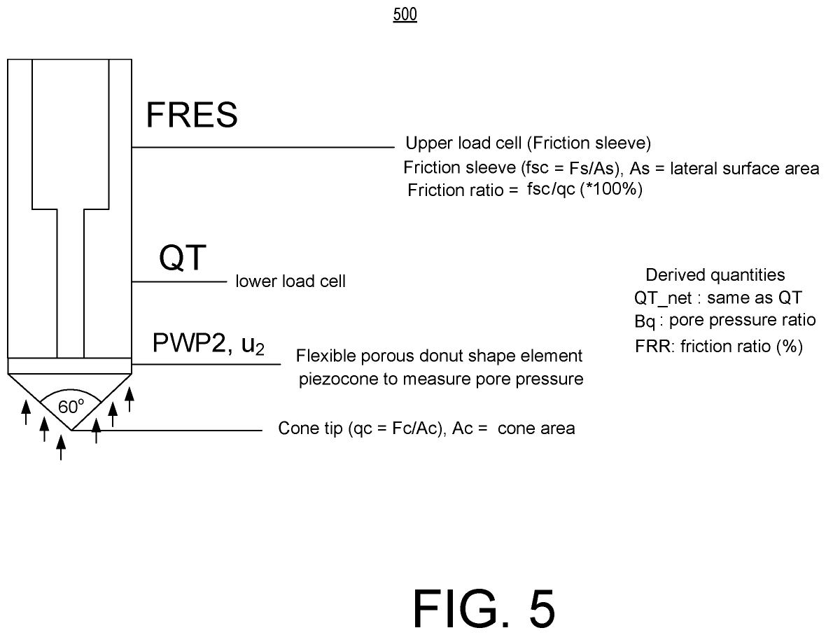

FIG. 5 shows an example of a CPT instrument 500 with respect to three types of measurements: load (QT), friction (FRES), and pore pressure (u₂ or pore-water pressure (PWP) at a sensor denoted “2”, PWP2). As shown, a lower load cell (see, e.g., the first sensor 372) can provide for measurement of cone related load (QT), an upper load cell (see, e.g., the second sensor 374) can provide for measurement of friction related load (FRES), and a fluid pressure sensor (see, e.g., the fluid pressure sensor 376) can provide for pore pressure (u₂); noting that in some instances a fluid pressure sensor may be referred to as a ‘second” sensor (e.g., denoted “2”). As explained, various types of values may be derived from these measurements. In various examples, whether a value is derived from one or more measurements or directly measured, it may be considered a CPT measurement or CPT data. In the example of FIG. 5, various areas (e.g., As, as lateral surface area, and Ac, as cone area) are presented, along with various other parameters; noting that in the field of CPT parameters may be represented in various forms, for example, using capital letters, small letters, subscripts, etc. (e.g., in logs, in articles, etc.).

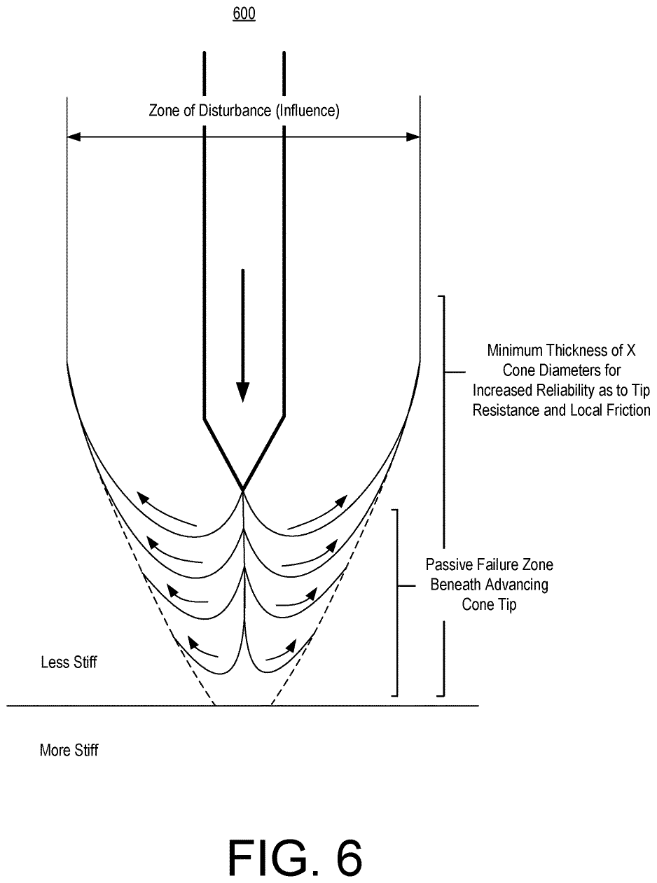

FIG. 6 shows an example of a CPT instrument 600 with respect to one or more possible zones of disturbance (or influence), which may help to explain how some depth shifts may occur (e.g., near transition zones of a stratified material, etc.). As an example, the FRES measurement may be sensitive in a lateral zone, the Bq measurement may be sensitive in a lateral and axial zone, and the QT measurement may be more sensitive in a lateral and axial zone, which includes an axial region in front of the cone. For example, a zone of influence for cone resistance may vary from approximately 1 to approximately 20 cone diameters according one or more factors such as, for example, soil stiffness and stress (see, e.g., Ahmadi and Robertson, 2011).

Historically, CPT development focused on use in soft earth materials. Over time, the development of additional sensors and heavier equipment extended the range of use. As shown in FIG. 6, the precise distance impacted below a cone tip can depend on stiffness and thickness of subsurface units (e.g., layers) being penetrated and on contrast in stiffness between adjacent beds. This influence can vary, for example, between about 20 cm to about 40 cm below a cone tip such that soundings may tend to overestimate unit strength parameters as the cone tip approaches a much stiffer horizon, such as soil-bedrock contact. The tip of the cone penetrometer can effectively sense out ahead of itself as it induces a local bearing failure of the soil through which it passes. The cone tip resistance recorded by the instrument tends to be an average across this tip influence zone. Therefore, some amount of care may be exercised when evaluating in situ strength parameters in various circumstances such as, for example, consider circumstances for horizons less than approximately 36 cm to approximately 72 cm thick (e.g., consider landslide slip surfaces, etc.).

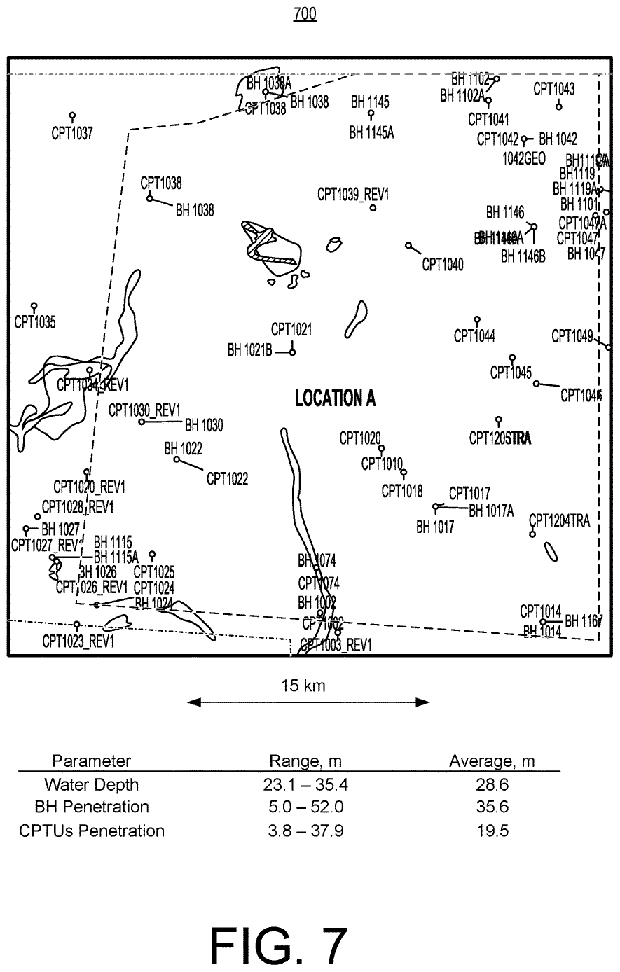

FIG. 7 shows an example of a site 700 with various CPT locations, for example, consider 10 or more locations for the site 700 where CPT data are to be acquired. In such an example, the data from the locations can be assessed to determine various physical properties of material at the site 700. As shown in FIG. 7, a table indicates ranges and averages for parameters of water depth, borehole (BH) penetration, and CPTs penetration, where these values are from 33 boreholes with CPTs and sampling, and 40 seafloor CPTs. In such an example, a workflow can involve determining locations and/or specifications (e.g., foundation specifications, etc.) for a number of wind turbines (e.g., consider a number from 1 to 100 or more) at the site 700. As an example, once specific locations are determined, one or more additional CPTs may be performed, for example, at one or more of the specific locations. Such an approach may provide for additional information that can be utilized to tailor foundation specifications (e.g., sizing, depth, material, construction, etc.) at one or more of the specific locations.

As an example, a workflow can involve various technologies such as, for example, technologies in geology, geophysics and geotechnics. As an example, a workflow may aim to match geotechnical data with geology data and geophysics data.

In the example of FIG. 7, each set of CPT data from each of the locations may differ and the sets of CPT data can be processed to arrive at measurement values that characterize the site 700 generally (e.g., overall or for a number of site regions, which may be referred to as groupings), noting that a foundation may be built at a particular location that may depend on data in one or more of the individual sets of CPT data. For example, if CPT data for a particular location indicate an anomaly that is not representative of the site as a whole and that is detrimental to a foundation or construction of foundation, then that location may be avoided. As explained, material can include anomalies such as, for example, one or more voids. Other types of anomalies may include objects, material that differs from a general stratigraphy, etc. In various instances, data acquired during a CPT may be lacking in quality at one or more depths for one or more reasons. For example, consider a porous material of a CPT instrument becoming plugged such that pore pressure values are inaccurate. Or, for example, consider one or more inaccuracies in sleeve friction measurement due to pore pressure effects on an end of the sleeve (see, e.g., Robertson, 2009).

As explained, a CPT instrument may acquire three types of measurements, which, from a physics point of view, can be quite different as to underlying phenomena. For example, pore pressure does not necessarily infer cone load and pore pressure, depending on fluid properties, may or may not effect friction as experienced by an outer surface of a shaft. As such, each of the CPT instrument measurements is somewhat decoupled from each of the others. Hence, correlations may be in various instances quite weak in that one measurement does not necessarily infer what another measurement should be. For various reasons, CPT data can differ substantially from data such as well log data, as may be acquired using downhole tools disposed in a borehole (e.g., wireline, coiled tubing, drilling, etc.). For example, a well logging tool can include multiple sensors that measure characteristics of a rock formation where, given a subset of measurements and a regression model, another measurement may be estimated with low error using an inversion technique. In such an example, consider so-called multi-physics inversion, which is a technique that can invert measurements for estimating other measurements and/or parameters using a model-based approach, or, for example, empirical equations such as Gardner's equation relating acoustic velocities to density. Such an approach relies on some commonalities between underlying physics, noting that the “multi-physics” term generally refers to different physics of sensors (e.g., gamma ray, electromagnetic resistance, nuclear magnetic resonance, etc.). For one or more reasons, the three aforementioned types of measurements of a CPT instrument may exhibit relatively weak correlations, which may lead to a conclusion, for purposes of site evaluation, that they are not sufficiently correlated. Given such realities, a site evaluation can aim to assure that a sufficient number of locations are selected for CPT data acquisition where a corresponding number of datasets can be acquired and analyzed to properly evaluate the site. In various instances, other differences with traditional wellbore logs used in the oil industry may be that some CPT logs cover a relatively shallower region of the subsurface (e.g., less than 100 m deep, etc.) and that data may be acquired at a relatively higher sampling rate (e.g., a higher sampling frequency than some wellbore logs).

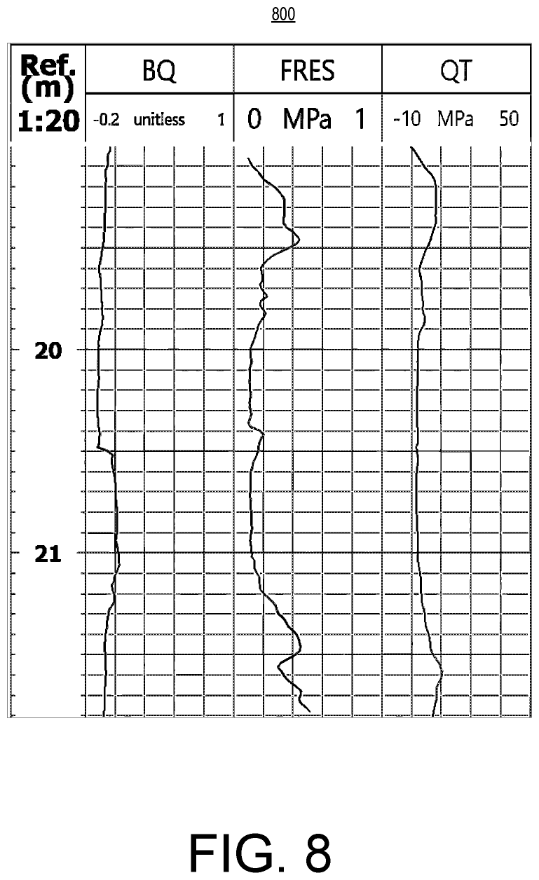

FIG. 8 shows a log plot 800 with tracks for Bq (or BQ), FRES, and QT with respect to depth in meters (m). As shown, Bq is on a unitless scale from −0.2 to 1, FRES is on a scale from 0 MPa to 1 MPa, and QT is on a scale from −10 MPa to 50 MPa. As explained, a site can include stratified material, which can be present in layers, which may be substantially horizontal, dipping, etc. As to dipping layers, CPT data for different locations may be adjusted to account for dip (e.g., angle with respect to horizontal) of one or more layers. Various other types of adjustments may also be made, as appropriate.

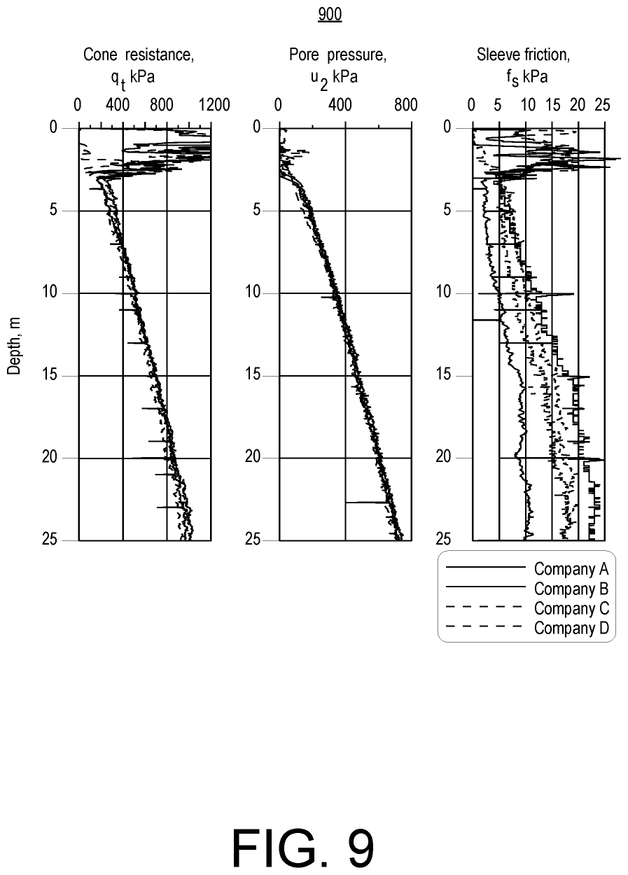

FIG. 9 shows three log plots 900, which include a cone resistance plot (QT or qₜ) ranging from 0 to 1200 kPa, a pore pressure plot (u₂) ranging from 0 to 800 kPa, and a sleeve friction plot (FRES or fₛ) ranging from 0 to 25 kPa, for depths from 0 meters to 25 meters. The three log plots 900 include CPT data acquired by four different companies.

The CPT data in the three log plots 900 is from offshore soil investigations, which involved different CPT instruments, particularly different cone types. The CPT data were acquired at a soft clay test site in Onsoy, about 100 km south of Oslo, with a number of cone penetrometers (CPTs), including at least four that are typically used offshore (e.g., from companies A, B, C, and D). The Onsoy site is very uniform both with depth and laterally. The CPT data show that there are no significant differences in the corrected cone resistance (qₜ) and the pore pressure (u₂) as long as the cones are properly saturated. However, the measured sleeve friction (fₛ) varied significantly, where typical results of CPTs carried out using cones operated in offshore soil investigations are included. The three log plots 900 demonstrate that one type of measurement may differ in its characteristics from other types. As explained, different measurement types can be weakly correlated due to different underlying physics, which may depend on one or more physical characteristics of a CPT instrument. Thus, when performing a site evaluation, consistency, number of locations, etc., can be factors in acquiring sufficient and accurate CPT data.

When characterizing the near surface area, CPTs represent a high-value measurement capable of performing an almost continuous in situ soil investigation. These data are broadly used in various applications, including offshore wind farm applications. However, performing data quality control for these data presents challenges.

To address various challenges, a framework can implement one or more machine learning technologies, which can include, for example, deep learning and machine learning methods for handling input CPT logs with one or more regions of low quality and/or one or more missing intervals. Such a framework can generate higher quality data with consistent, complete measurements.

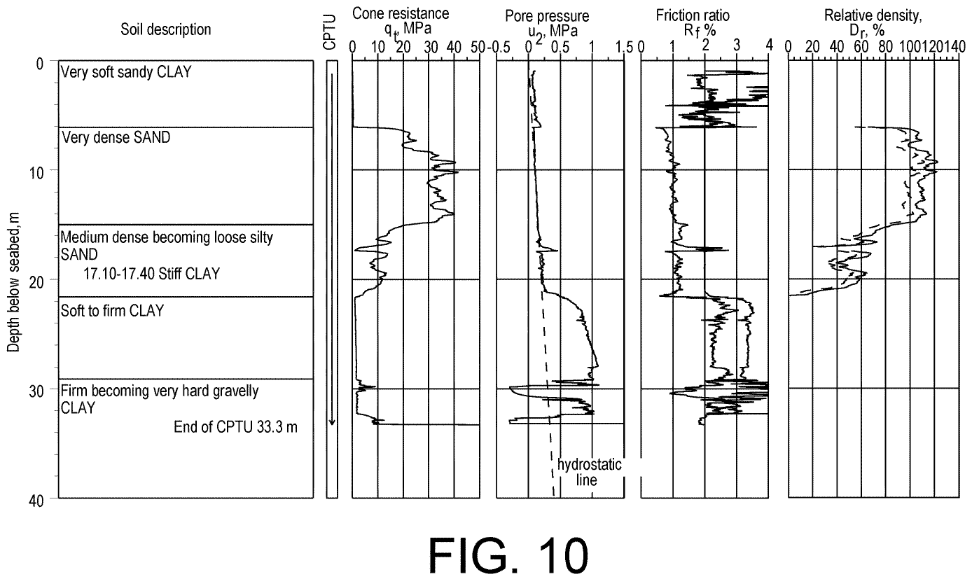

FIG. 10 shows example logs 1000 that may be considered for interpretation using a framework, which is a computational framework that can implement one or more machine learning models (ML models). As shown, the logs 1000 include cone resistance (qₜ), pore pressure (u₂), friction ratio (R_{f}), and relative density (Dᵣ) for stratified material that includes very soft sandy clay (e.g., 0 m to 3 m), very dense sand (e.g., 3 m to 13 m), medium dense becoming loose silty sane (e.g., 13 m to 21 m), soft to firm clay (e.g., 21 m to 29 m), and firm becoming very hard gravely clay (e.g., 29 m to 33.3 m).

In the logs 1000, CPTs were performed using penetrometers with a 500 mm² (CP5) cone tip and a 1000 mm² (CP10) cone tip area, which measure cone resistance (q_{c} or qc) and sleeve friction (fₛ or fs). The CP10 cone additionally measures pore pressure at the shoulder of the cone (u₂). CP5 cones were used in very dense sands due to its more robust design allowing the cone to penetrate the soil and minimizing the risk of damage to equipment. Calculated cone values such as net cone resistance (qₙ), total cone resistance (qₜ) and pore pressure ratio (Bq) are therefore presented only for the CPTs performed with the CP10 cones, as these parameters require the pore pressure to be calculated.

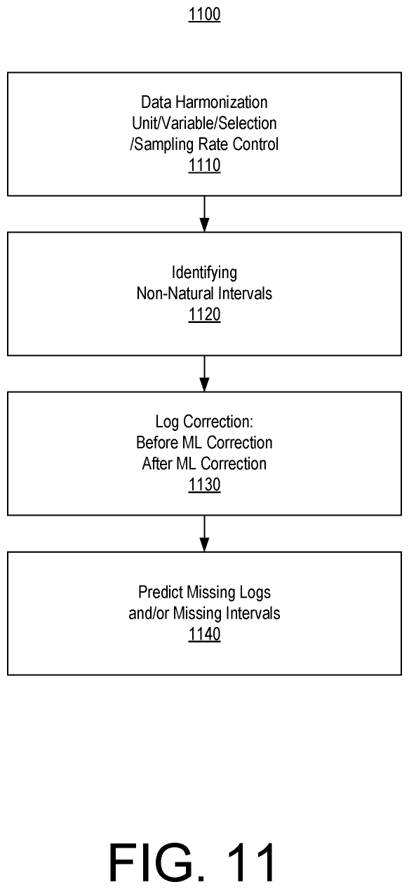

FIG. 11 shows an example of a workflow 1100 for processing data such as the data in the logs 1000. As shown, the workflow 1100 includes a data harmonization block 1110 for preprocessing data as to units, variable selection and sampling rate control, a identification block 1120 for identifying non-natural intervals (e.g., using cross-plots of different measurements such as QT versus BQ, as derived from u₂ and QT), a log correction block 1130 for performing ML model based corrections (e.g., adjustments) to CPT logs, and a prediction block 1140 for predicting missing logs and missing intervals. The workflow 1100 can be implemented by a framework, which may be part of a system such as, for example, the system 300, the system 400, etc., which may be integrated into a method such as, for example, the method 200 for purposes of constructing one or more foundations.

As an example, a framework may include a foundation generation component that can, for example, utilize output of the workflow 1100 to generate foundation characteristics for constructing a foundation or foundations at a site. For example, consider a ML model-based approach that is trained using data as to existing foundations at various sites where CPT data are available and associated with such sites. In such an approach, given the output of the workflow 1100, the ML model can generate foundation characteristics and/or identify suitable (e.g., optimal) foundations that exist from which insights can be gained for construction of a new foundation. As an example, a framework may include various features that may account for equipment at a site, such as, for example, wind energy production equipment, which may be associated with operational data, which can include environmental data such as wind direction, wind speed, etc. (e.g., as may depend on seasonal variations, etc.).

As explained, CPT data can be used to characterize material (e.g., soil). For example, consider a soil behavior type index, I_{c}, which can be thought of as a representative value that combines Qₜ and Fᵣ to produce concentric circles delineating Robertson's 1990 SBT chart zones. In such an approach, I_{c} may express the radius of those concentric circles:

$${I}_{C} = {( {( 3.47 - log {Q}_{t} )}^{2} + {( log {F}_{r} + 1.22 )}^{2} )}^{0.5}$$

As another example, consider soil unit weight, γ, where the following relationship from Robertson expresses the soil unit weight in terms of the friction ratio and cone resistance:

$$γ / {γ}_{w} = 0.27 ( log {R}_{f} ) + 0.36 ( log ( {q}_{t} / {P}_{a} ) ) + 1.236$$

In the foregoing equations of Robertson, Fᵣ is equal to (fₛ/(qₜ−σᵥₒ))100%, where σᵥₒ is the in situ vertical stress; Pₐ is atmospheric pressure; γ_{w} is the unit weight of water (e.g., in units of kN/m³); and R_{f} is the friction ratio, which may be R_{f}=(fₛ/q_{c})100%, where q_{c} is the uncorrected cone resistance; noting that the difference between q_{c} and qₜ tends to be small, except in soft fine grained soils where q_{c}<1 MPa such that R_{f} can be equal to (fₛ/qₜ)100%. According to Robertson, BQ (or Bq) can be defined as (u₂−u₀)/(qₜ−σᵥₒ), where u₀ is the in situ equilibrium water pressure.

As explained, various CPT measurements can be used to determine soil characteristics, which, in turn, can facilitate foundation design and construction. As an example, a framework can include such relationships such that a link is established between CPT data and foundation design and construction for one or more of various types of equipment. An article by Robertson, P. K., “Interpretation of cone penetration tests—a unified approach”. Paper published by NRC Research Press, doi:10.1139/T09-065 (2009), is incorporated by reference herein in its entirety.

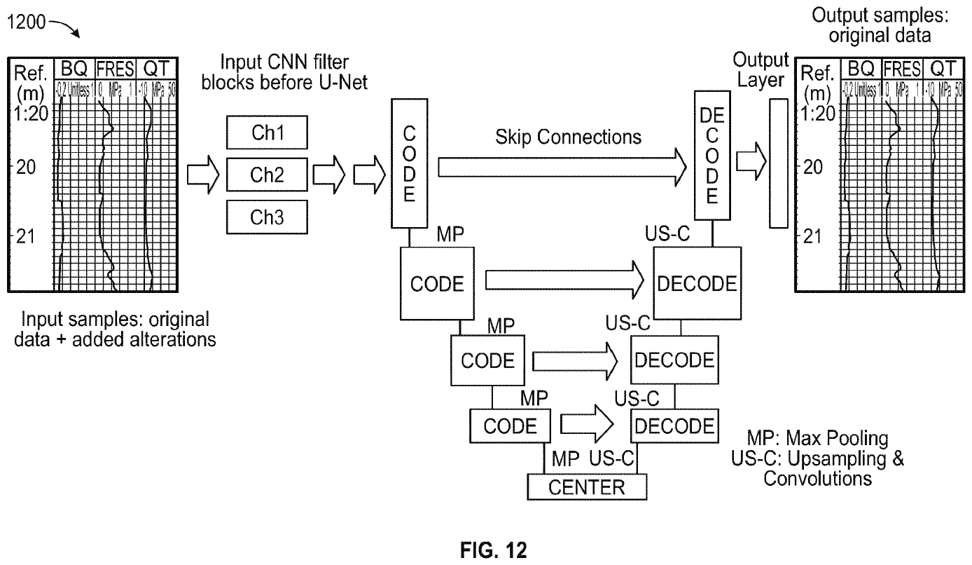

FIG. 12 shows an example of an architecture 1200 for a ML model that includes input convolution neural networks (CNNs) that precede a U-Net architecture, which includes skip connections, max pooling (MP), upsampling and convolutions (US-C), an outer layer, coder blocks, and decoder blocks. As shown, coder blocks (C) provide for transformation from CNN processed input to a center (e.g., a contracting path) while decoder blocks (D) provide for transformation to the output (O) (e.g., an expansive path); hence, a “U” shaped structure.

As an example of a U-Net architecture, consider the U-Net architecture as described in an article by Ronneberger et al., “U-Net: Convolutional Networks for Biomedical Image Segmentation,” arXiv:1505.04597 (2015), which is incorporated herein by reference in its entirety. Such an architecture includes a contracting path and an expansive path. The article by Ronneberger et al. describes a contracting path that follows an architecture of a convolutional network (e.g., a CNN) and that includes repeated application of convolutions and use of a rectified linear unit (ReLU) along with a max pooling operation with a specified stride for downsampling where, in an expansive path, upsampling of a feature map can be performed followed by convolution.

Specifically, the article by Ronneberger et al. describes a network architecture that includes a contracting path (left side) and an expansive path (right side) where the contracting path follows an architecture type of a convolutional network and includes repeated applications of two 3×3 convolutions (unpadded convolutions), each followed by a rectified linear unit (ReLU) and a 2×2 max pooling operation with stride 2 for downsampling. At each downsampling step, the number of feature channels is doubled. In the article by Ronneberger et al., each step in the expansive path includes an upsampling of the feature map followed by a 2×2 convolution (“up-convolution”) that halves the number of feature channels, a concatenation with the correspondingly cropped feature map from the contracting path, and two 3×3 convolutions, each followed by a ReLU. The cropping handles loss of border pixels in each convolution. At the final layer a 1×1 convolution is used to map each 64-component feature vector to the desired number of classes. In total, the network of Ronneberger et al. includes 23 convolutional layers.

As to training, consider an approach of Ronneberger et al., where input images and their corresponding segmentation maps are used to train the network with the stochastic gradient descent implementation of the CAFFE framework (Berkeley AI Research (BAIR), Berkeley, California). Due to the unpadded convolutions, the output image is smaller than the input by a constant border width. To minimize the overhead and make maximum use of GPU memory, Ronneberger et al. favored large input tiles over a large batch size and hence reduced the batch to a single image where a high momentum (0.99) was utilized such that a large number of the previously seen training samples determined the update in a current optimization step. As explained, one or more other approaches may be utilized for purposes of training, which may train the same type of ML model or one or more other types of ML models.

In the example architecture 1200 of FIG. 12, note that 1 D CNNs are used to filter data prior to input into the U-Net (e.g., as individual channels, etc.). As explained, CPT data can include inaccuracies, artifacts from anomalies, inconsistencies, gaps in data, etc. Further, as explained, there may be a lack of correlation between various CPT measurements. As such, if CPT logs were directly input to the U-Net, there may be a lack of matching between input and output such that the U-Net itself is not accurately trained. To address such an issue, the architecture 1200 processes the logs individually as individual handling can help to assure that each log, by itself, is properly filtered (e.g., as mentioned, there may be a lack of correlation between channels). As an example, another possible alteration, compared to the original architecture, can build each of the blocks that may contain padded convolutions and utilize a different number of convolutional layers.

In the examples of FIG. 11 and FIG. 12, benefits of a data-driven workflow can reduce the time for outlier identification, log correction, and log prediction using machine learning and to provide consistent predictions that facilitate downstream applications such as seismic to well tie, field property prediction, and core to CPT logs correlation.

As an example, a framework can perform a workflow for CPT data quality control using: outlier detection, log correction (see, e.g., Simoes et al., “Deep Learning for Multiwell Automatic Log Correction.” Petrophysics 63 (2022): 724-747. doi: https://doi.org/10.30632/PJV63N6-2022a10, which is incorporated by reference herein in its entirety and Simoes et al., “Deep Learning for Multiwell Automatic Log Correction.” Paper presented at the SPWLA 63rd Annual Logging Symposium, Stavanger, Norway, June 2022, which is incorporated by reference herein in its entirety), and prediction of missing basic and advanced logs (see, e.g., Simoes et al., “A Comparative Study for Machine-Learning-Based Methods for Log Prediction”; Paper presented at the SPWLA 63rd Annual Logging Symposium, Stavanger, Norway, June 2022, which is incorporated by reference herein in its entirety).

As an example, a workflow can harmonize CPT data, for example, to address names and units. Such a workflow can then build a first outlier detection process using statistical techniques to detect anomalous intervals in each CPT log. Such a process can be performed using a joint data distribution of basic CPT measurements and statistical analysis to flag depths with rare appearances, unsupervised clustering techniques and/or one or more rule-based techniques. Next, such a workflow can include constructing an ML model (e.g., deep learning, etc.) and training the model using a self-supervised approach with multiple CPT logs being distorted according to random and/or systematic alteration, for example, to augment and/or supplement the amount of training data available (e.g., optionally mimicking types of issues that may be apparent in acquired CPT data, etc.). As an example, distortions may be introduced for one or more purposes, which may include data augmentation and/or challenging a model to learn data intercorrelations and distributions, while, for example, at the same time, learning to denoise data and teach a model to predict missing intervals given a variety of information. As to an ML model and a self-supervised approach on unidimensional subsurface data (e.g., subsurface data composed of multiple data channels), see, e.g., the three articles of Simoes et al., as cited above. As to self-supervised tasks on language data, see, e.g., Devlin et al. “BERT: Pre-training of Deep Bidirectional Transformers for Language Understanding”; In Proceedings of the 2019 Conference of the North American Chapter of the Association for Computational Linguistics: Human Language Technologies, Volume 1 (Long and Short Papers), pages 4171-4186, Minneapolis, Minnesota. Association for Computational Linguistics, which is incorporated by reference herein in its entirety.

As an example, a pre-trained model using CPT logs and a self-supervised approach can be adapted to one or more downstream tasks. For example, consider one or more of predicting missing logs, predicting normalized curves, predicting derived and/or interpreted curves (e.g., soil behavior type, etc.), determining presence of one or more channels, deriving one or more additional and/or alternative logs (e.g., gamma ray, shear wave, etc.). As an example, embedded features from a pre-trained model may be used as part of one or more machine learning models. For example, consider use with one or more other neural network models and/or one or more tree-based models. In such an approach, a pre-trained model may be utilized in one or more workflows for performing one or more tasks that may be related to soil characteristics. As an example, a workflow may be a multi-physics workflow that involves CPT logs and one or more other types of logs. As an example, a workflow may be an inversion workflow that aims to generate one or more models based on one or more types of logs. In such an example, the workflow may be iterative and utilize forward modeling and inversion to generate a model (e.g., an earth model, etc.). In such an example, more accurate logs may provide for improved convergence and/or generation of a more accurate model.

As an example, in the workflow, an ML model can be trained on a subset of field data and used to predict remaining data of the field, which may be for one or more depths that have been identified as anomalies in the original data set. As an example, in the workflow, intervals with predicted values far from the original logs can be flagged as outliers, for example, consider defining “far” according to one or more distance metrics such as, for example, relative absolute error compared to model and measurement uncertainties.

As an example, the workflow can include using the anomaly-free dataset to train a model to predict and/or reconstruct curves where outliers have been detected and/or where a certain measurement or measurements are not available for one or more intervals and/or for an entire CPT location (e.g., consider missing data); noting that a workflow can also provide for output of derived/interpreted information such as, for example, one or more of normalized curves, soil behavior type, shear wave velocities, bulk, and shear moduli, coefficient of consolidation and one or more other types of information.

In various trials, such a workflow was performed using field datasets where the workflow implemented the architecture 1200 of FIG. 12 (e.g., 1D CNNs and U-Net). Various other trials implemented XGBoost (eXtreme Gradient Boosting) as well as 1D convolutional neural networks (1D-CNN), noting that one or more other ML techniques may be applied. For example, XGBoost may be implemented in combination with one or more types of machine learning models (e.g., one or more CNNs, with U-Net structure, other structure, etc.).

As an example, XGBoost can be implemented to predict one or more CPT logs, for example, consider prediction of a missing CPT log. As an example, XGBoost can be implemented for prediction to flag one or more outliers, for example, where a curve differs from an original curve. An XGBoost approach can provide suitable results in a field application and can find use in one or more other subsurface modeling workflows (see, e.g., Simoes et al., “A Comparative Study for Machine-Learning-Based Methods for Log Prediction.” Paper presented at the SPWLA 63rd Annual Logging Symposium, Stavanger, Norway, June 2022). As mentioned, one or more types of ML models may be implemented, which can include one or more of CNNs (e.g., 1D, multiscale, etc.), window-based convolutional neural network autoencoders (WAEs), pointwise fully connected autoencoders (PAE), tree-based pointwise XGBoost models, etc.

XGBoost is an optimized distributed gradient boosting library designed to be highly efficient, flexible and portable. It implements machine learning algorithms under the Gradient Boosting framework. XGBoost provides a parallel tree boosting (also known as GBDT, GBM) for application to data science problems in a fast and accurate way. The same code runs on major distributed environment (Hadoop (Apache Software Foundation, Forest Hills, Maryland), Oracle Grid Engine (OGE or SGE, Oracle, Austin, Texas), Message Passing Interface (MPI), etc.) and can solve problems beyond billions of examples. XGBoost works as Newton-Raphson in function space unlike gradient boosting that works as gradient descent in function space, a second order Taylor approximation can be used in the loss function to make the connection to Newton-Raphson method.

As an example, a workflow can include acquiring CPT data for training data from multiple locations at a site and, to supplement and/or augment such data, one or more techniques such as random distortion, etc., may be applied (e.g., to generate distorted CPT logs, etc.). As an example, a trained ML model can be applied to data from a single location at a site (e.g., one set of CPT data) where the underlying ML model is trained using data from multiple locations at the site. For example, an ML model can be trained using a datasets of multiple CPT locations, where a trained ML may be applied to each set of curves (e.g., three curves) for each CPT location to thereby improve the quality of the CPT data for each location. In such an approach, a method such as, for example, the method 200 of FIG. 2 can provide for improved foundation design, construction, etc., which, in turn, may improve operation and/or longevity of equipment supported by a foundation or foundations.

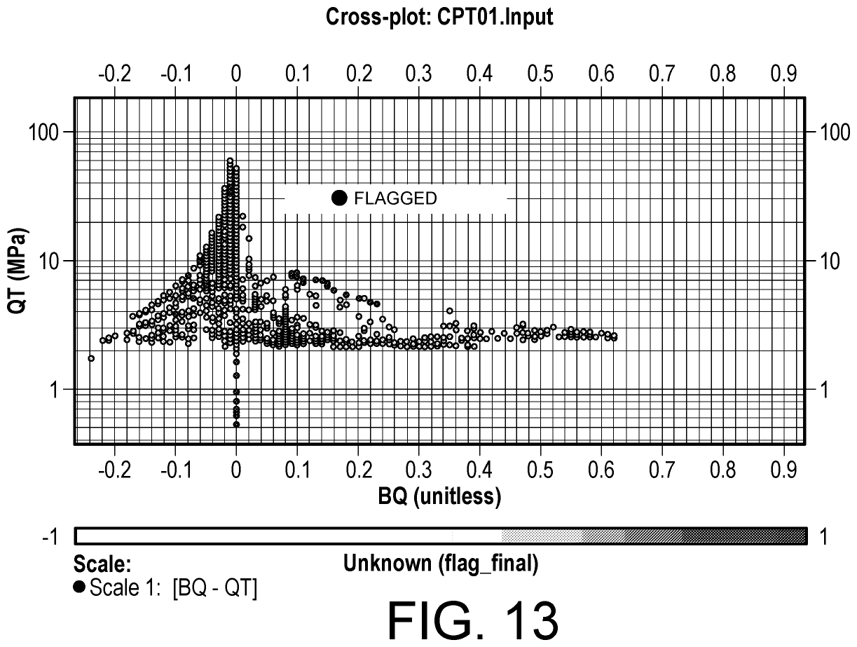

FIG. 13 shows an example cross-plot 1300 of QT versus BQ that shows how data can be identified (e.g., flagged or not flagged). As explained, cross-plots can be implemented to identify data that may lack physical relevance and/or exhibit one or more other types of issues.

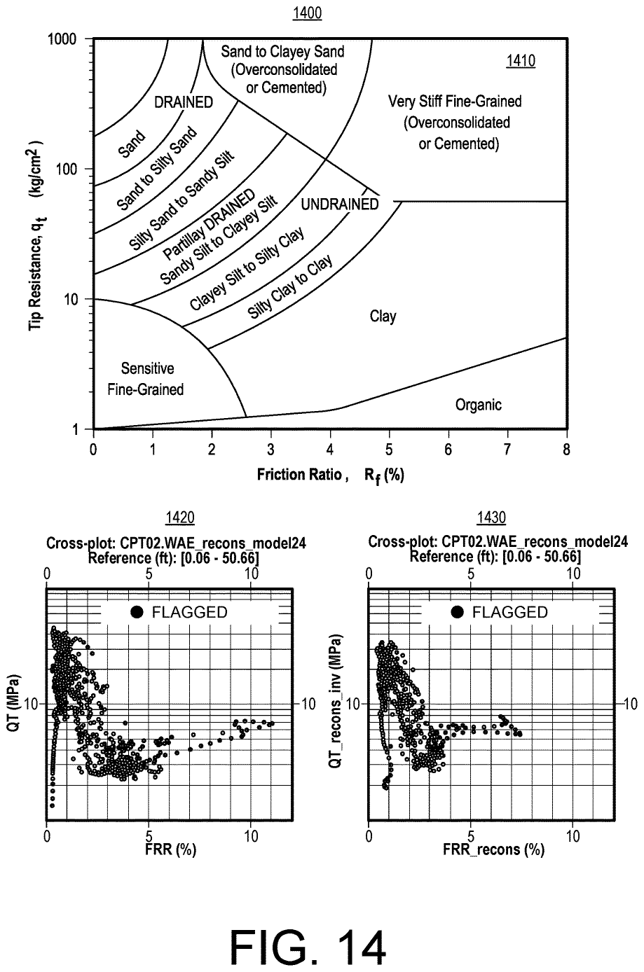

FIG. 14 shows examples of plots 1400 where a plot 1410 shows material characteristics as a map of qₜ (tip resistance) versus R_{f} (friction ratio), a plot 1420 of cross-plotted data for anomaly detection before application of a machine learning technique, and a plot 1430 of cross-plotted data for anomaly detection after application of a machine learning technique.

As an example, a workflow can include comparing data-driven results with domain specific cross-plots, to see how flags are distributed along a domain specific cross-plot. As explained, cross-plots can be utilized for various purposes, which can include soil characterization, which can facilitate understanding of stratigraphy and foundation design, construction, etc. As explained, various equations such as those by Robertson (see above) can be utilized to generate maps with regions that characterize soils (e.g., soil types, soil behaviors, etc.). In the plot 1420 of FIG. 14, the flagged points in red coincide with the points far from the main trend and some flagged points with FRR>6% or FRR>8% include values outside the intervals found in literature.

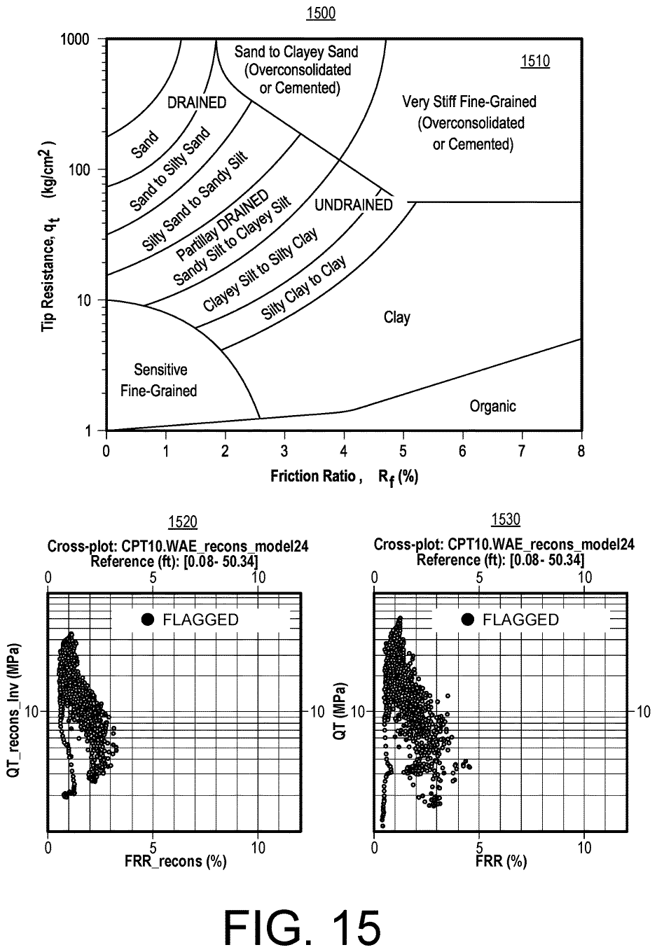

FIG. 15 shows examples of plots 1500 where a plot 1510 shows material characteristics as a map of qₜ (tip resistance) versus R_{f} (friction ratio), a plot 1520 of cross-plotted data for impact of log reconstruction before application of a machine learning technique, and a plot 1530 of cross-plotted data for impact of log reconstruction after application of a machine learning technique.

As shown in the plots 1420, 1430, 1520, and 1530, a framework can apply one or more machine learning techniques for improved anomaly detection and log reconstruction.

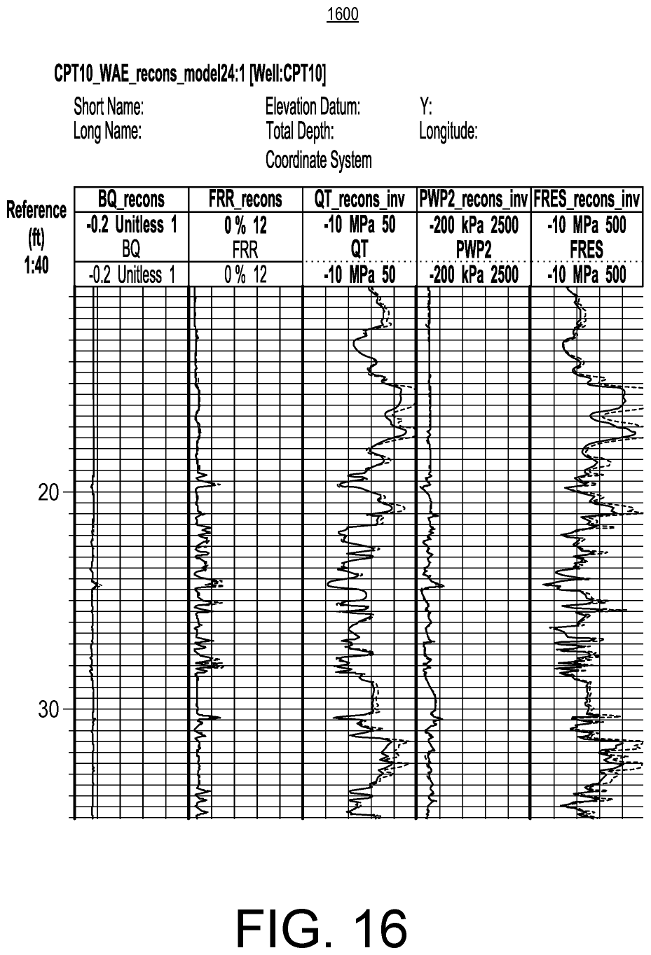

FIG. 16 shows example logs 1600 as reconstructed along with original logs. In the example logs 1600, BQ_recons aligns well with BQ; FRR_recons aligns well with FRR noting an improvement in the FRR_recons around 22 m to 23 m; QT_recons_inv improves upon QT; PWP2_recons_inv (e.g., u₂ reconstructed) improves somewhat upon PWP2; and FRES_recons_inv improves upon FRES. The example logs 1600 demonstrate how a framework can improve quality of CPT logs. In the example logs 1600, a WAE model was implemented for data denoted CPT10 data; noting that one or more other types of ML models may be utilized by a framework in one or more workflows.

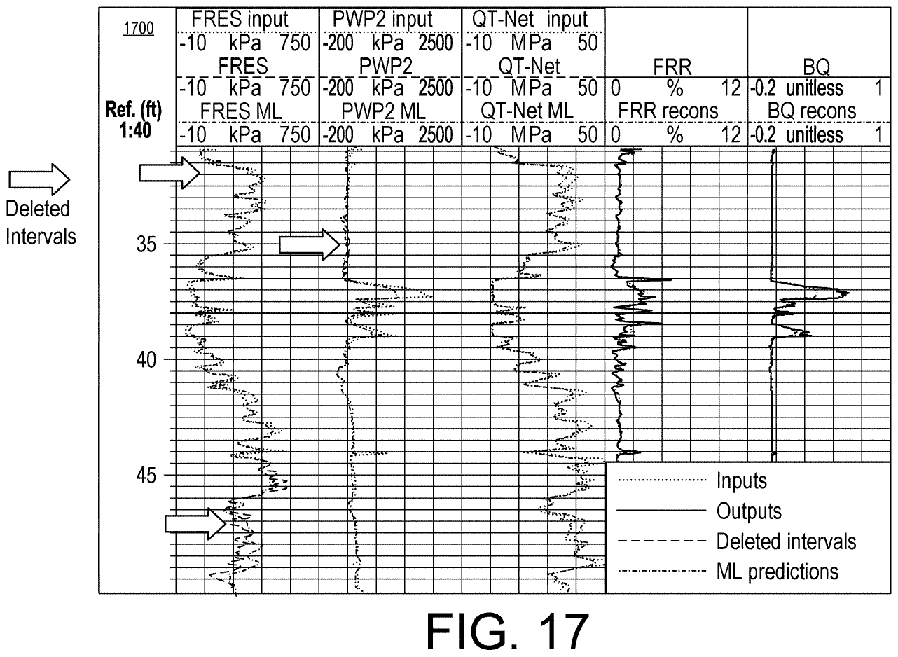

FIG. 17 shows example logs 1700, which include input logs, output logs, deleted intervals, and predicted intervals. As explained, an interval may be non-existing or may be deleted where a ML model can be applied to predict values for that interval. Such an approach can improve the quality of CPT logs.

As an example, a framework can handle CPT data in a manner that can address non-repeatability issues as to pore water pressure and lower accuracy of sleeve friction. Other challenges addressed through a framework can involve missing intervals or missing data and poor-quality measurements, particularly in the beginning of a CPT run.

As explained, a framework can implement a CPT log quality control (QC) workflow that can improve CPT log quality, for example, by providing a more consistent and complete set of CPT logs as well as an outlier flag for anomalous data.

As an example, a CPT log QC workflow can utilize machine learning to learn from neighboring wells and inter log correlation and given poor quality of measurement(s) in some regions, the workflow can be used to improve general data quality, for example, by providing a more consistent and complete set of CPT logs as well as an outlier flag for anomalous data.

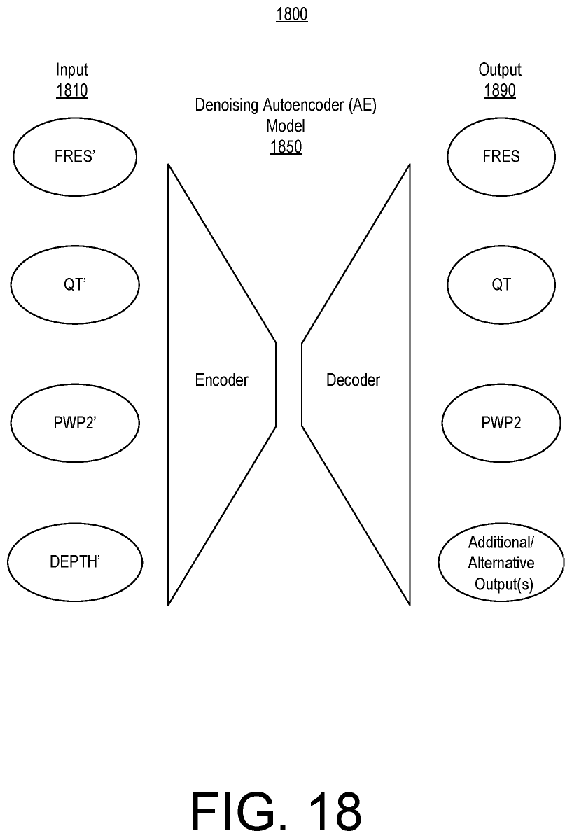

FIG. 18 shows an example of a system 1800 that includes a model 1850 that can receive input 1810 and generation output 1890. As shown, the model 1850 may be a denoising autoencoder (AE) model (e.g., an autoencoder). As shown, the model 1850 includes an encoder and a decoder.

In general, an AE approach involves an encoder that maps input to representations in a low-dimensional space (e.g., a latent space, etc.) and a decoder that operates on the representations in the low-dimensional space to generate output that aims to effectively be the same as the input. In various instances, a workflow may involve training of an AE model followed by using only a portion of the trained AE model such as, for example, the encoder as a trained encoder for purposes of dimensionality reduction, etc.

As an example, the AE model 1850 may operate in a self-supervised manner where the AE model 1850 attempts to predict some parts of the input 1810 from other parts of the input 1810.

As an example, a self-supervised approach may be implemented using an encoder and a neural network that may differ from a decoder. For example, consider utilizing an encoder to reduce dimensionality in a manner that retains particular aspects of input followed by training of a neural network (NN) that can map the latent space representations of the input into output that may be an improved representation of the original input and/or that may include one or more other types of output (e.g., other types of logs, metrics, indexes, etc.). In such an example, the output may be a refined representation of the input (e.g., with more signal, less noise, filled gaps, etc.). Such an approach may be referred to as an encoder-NN approach where an encoder is first trained along with a decoder where the trained encoder is then paired with a NN that can be trained to generated desired output.

As mentioned, the AE model 1850 can be a denoising autoencoder (e.g., a denoising AE or DAE). As an example, a denoising AE may be trained using input to which noise has been added such that a model is generated with an ability to perform denoising. For example, consider an input vector to which noise is added. In such an example, a surrogate target of a decoder may remain the input vector. In such an example, the encoder may operate to diminish added noise when encoding. Thus, the trained encoder can be more robust to noisy input. Such an approach may be considered a type of AE driven data augmentation. That is, by adding noise, more training data are generated to train the AE model. In general, a denoising AE approach may not suffer from the problem of learning an identity mapping (e.g., as with a Vanilla AE) because, for a denoising AE, the input differs from the target, and the identity mapping is not the optimal solution.

As an example, a workflow may provide for acquiring and/or generating data and corrupted data for use an input into a denoising AE where training aims to generate uncorrupted data. Such a denoising AE can be trained to minimize a loss function that includes uncorrupted input and corrupted input where upon training, the denoising AE learns to undo corruptions rather than merely identically representing its input. As an example, a denoising AE may learn a reconstruction distribution estimated from training pairs of data and corrupted data. For example, consider a workflow that includes sampling a training sample from training data, sampling a corrupted version of the training sample through application of a corruption process, and using the samples as a pair for estimating a reconstruction distribution, which may be included in a loss function (e.g., to be minimized).

As explained, a denoising AE may be given partially corrupted input data and trained to restore the original input by removing corrupt information through dimensionality reduction. Unlike many AEs, a denoising AE does not have the entire ground truth as input; rather, corruption may be applied to uncorrupted data, corruption to data with known corruptions, etc., for input. For example, Gaussian noise may be added to data where a denoising AE effectively learns to filter out the Gaussian noise. As explained, during model training, reconstruction error of denoised output may be measured against uncorrupted data (e.g., the ground truth). A denoising AE approach may help to reduce issues as to overfitting, which may conserve time and/or resources.

As explained, a model may include at least a trained encoder, for example, as operatively coupled to a decoder and/or a neural network. In such an approach, corrupted data (e.g., data with noise, gaps, etc.) may be received and improved data generated. As an example, a model may provide for generation of data that may be beyond the types of data utilized as input. For example, consider a model that may receive CPT data and generate improved CPT data and/or other data. In such an example, the other data may be other type of log data as may be related to and/or depend upon material characteristics represented in CPT data.

As an example, a workflow may include implementing deep learning with self-supervised tasks applied to altered CPT log intervals from validation CPT locations. In such an example, model performance may be evaluated and, for example, model improvements made.

As shown in the example system 1800 of FIG. 18, input may include channels such as CPT log channels with alterations (e.g., noise, corruptions, etc.). For example, consider the following CPT log channels where alterations have been applied to at least a portion of data: FRES′, QT′, and PWP2. As shown, the input 1810 can include such data along with depth, which may also be subjected to alterations (e.g., uncertainty as to actual depth, etc.). As to the output 1890, it may include CPT log channels FRES, QT, PWP2, and one or more additional or alternative outputs. As explained, while the model 1850 is presented as an AE type of model, a model may provide for the same or similar outputs given such inputs through use of an encoder (e.g., a trained encoder) and a neural network.

As an example, a model may provide for output of denoised logs (e.g., QT denoised, FRES denoised, PWP2 denoised, etc.) and/or one or more additional and/or alternative logs (e.g., FRR predicted, I_{C} predicted (or IC), I_{SBT} predicted (e.g., or Ibst, as the non-normalized soil behavior type index), etc.).

In various example trials, field data were taken from a public database for the Ten noorden van de Waddeneilanden Wind Farm Zone (TNWWFZ) located approximately 56 kilometers (km) off the north coast of the Netherlands.

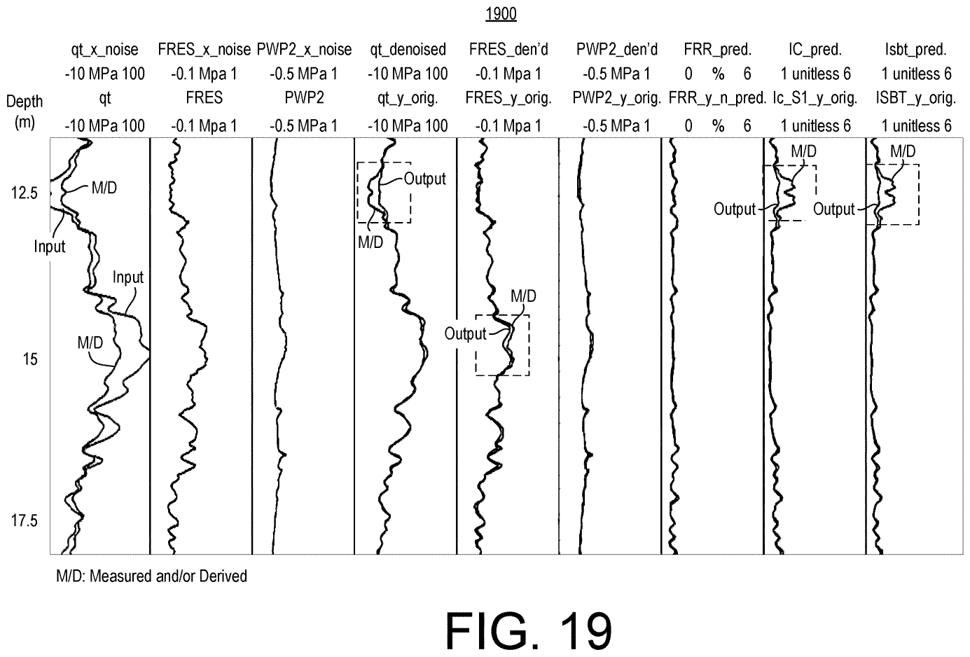

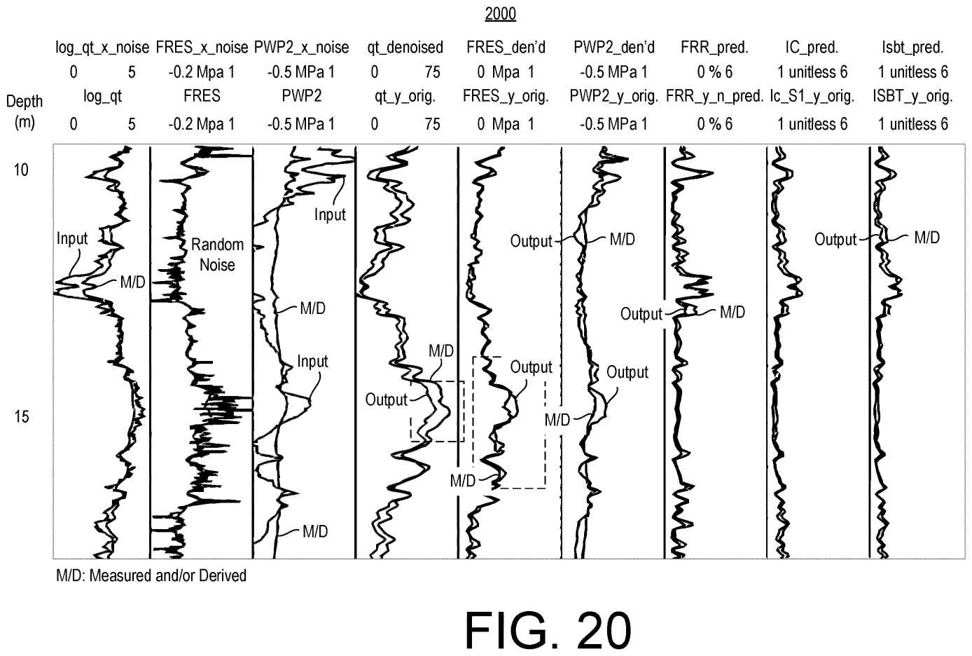

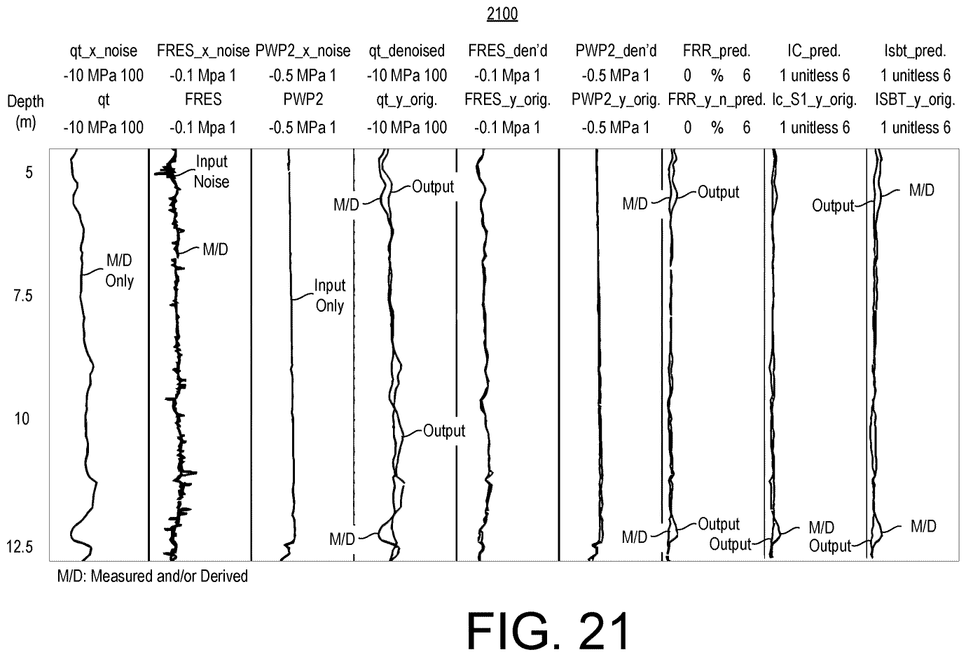

FIG. 19, FIG. 20, and FIG. 21 show example graphical user interfaces 1900, 2000, and 2100 with example plots, specifically logs, as to field data from the aforementioned TNWWFZ database.

In the example of FIG. 19, the GUI 1900 demonstrates how a trained ML model can handle missing QT information and spikes on FRES data. As shown, I_{C} and IBST may be generated as output, which may be on a unitless basis and assigned numeric values from 1 to 6; noting that the number or types of zone may differ from the six indicated. For example, a 12 SBT zone approach, a 9 SBT zone approach, etc., may be utilized. As to the index I_{SBT}, it may be expressed, for example, as follows:

$${{I}_{SBT} = {( 3.47 - log ( {q}_{c} / {p}_{a} ) )}^{2} + {( log ( {R}_{f} ) + 1.22 )}^{2} )}^{0.5}$$

where q_{c} is the CPT cone resistance (or corrected cone resistance, QT, qt, qₜ, or Qₜ), Rf is the friction ratio (fₛ/q_{c}) multiplied by 100 percent, and fₛ is the CPT sleeve friction.

As to the index I_{C}, as mentioned, it may express the radius of concentric circles, for example, as follows:

$${I}_{C} = {( {( 3.47 - log ( {Q}_{t} ) )}^{2} + {( log ( {F}_{r} ) + 1.22 )}^{2} )}^{0.5}$$

As explained, a model may provide for generation of various outputs even where data may be noisy, include gaps, include uncertainty as to depth, etc.

In the example of FIG. 20, the results demonstrate an ability to handle larger alterations on the QT log (e.g., QT channel).

In the example of FIG. 21, the results demonstrate an ability to handle missing QT log data (e.g., missing or otherwise corrupted QT channel data) and spikes on the FRES log (e.g., FRES channel).

While a framework may handle CPT data, such a framework may be applicable for improving data quality for one or more other subsurface applications using curves such as and not limited to production logging tool, fiber optics, drilling curves.

As explained, a framework can utilize one or more machine learning techniques (e.g., deep learning) to improve CPT log quality; specifically, via implementation of a denoising approach during self-learning, where data distortion can be adapted to the nature of CPT logs and their anomalies, which can force an ML model to learn interdependence between the curves (logs).

As an example, a framework can reduce turn-around time for CPT logs and provide corrections that are of high quality. Such a framework may be operatively coupled to one or more other frameworks such as, for example, one or more of a data handling framework and a data intelligence framework. For example, consider an approach that can increase use of the TECHLOG framework (SLB, Houston, Texas) and/or the DATAIKU framework (DATAIKU, New York City, New York) for applications such as, for example, wind farm applications. The TECHLOG framework includes features for acquisition of data, pre-processing of data, analysis of data, interpretation of data, presentation of data, etc. The TECHLOG framework can provide for interpret of various types of data (e.g., log data, core data, etc.).

As an example, a framework can provide for improved site characterization as to near subsurface characterization, which may be applied in onshore and/or offshore wind farm or, for example, deep-water oil and gas exploration, where the framework can accelerate quality control of CPT logs and/or one or more other log types.

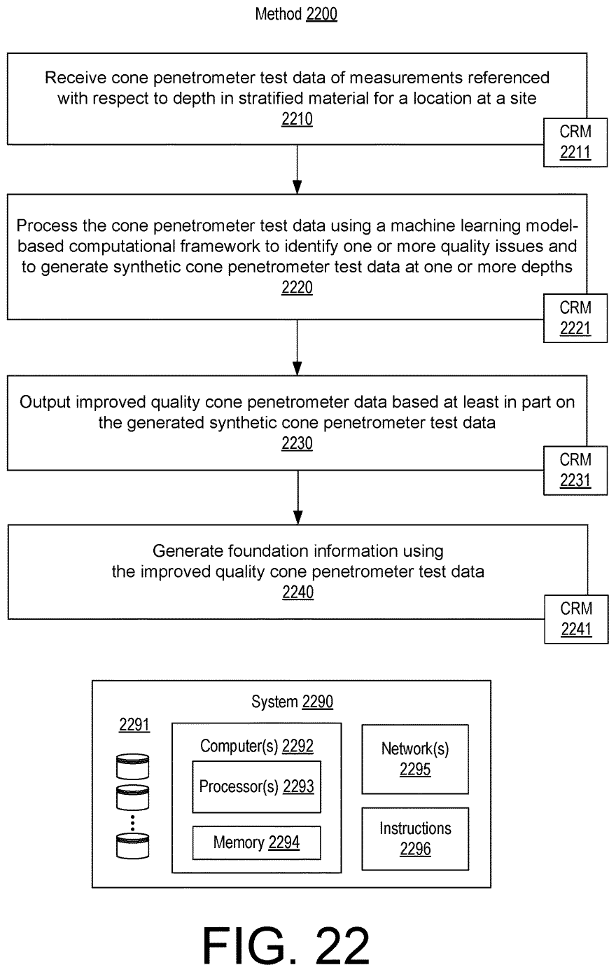

FIG. 22 shows an example of a method 2200 and an example of a system 2290. In the example of FIG. 22, the method 2200 can include a reception block 2210 for receiving cone penetrometer test data of measurements referenced with respect to depth in stratified material for a location at a site; a process block 2220 for processing the cone penetrometer test data using a machine learning model-based computational framework to identify one or more quality issues and to generate synthetic cone penetrometer test data at one or more depths, and an output block 2230 for outputting improved quality cone penetrometer data based at least in part on the generated synthetic cone penetrometer test data. As an example, the method 2200 can include a generation block 2240 for generating information as to one or more foundations for the site.

In the example of FIG. 22, the system 2290 includes one or more information storage devices 2291, one or more computers 2292, one or more networks 2295 and instructions 2296. As to the one or more computers 2292, each computer may include one or more processors (e.g., or processing cores) 2293 and a memory 2294 for storing the instructions 2296, for example, executable by at least one of the one or more processors. As an example, a computer may include one or more network interfaces (e.g., wired or wireless), one or more graphics cards, a display interface (e.g., wired or wireless), etc.

The method 2200 is shown along with various computer-readable media blocks 2211, 2221, 2231, and 2241 (e.g., CRM blocks). Such blocks may be utilized to perform one or more actions of the method 2200. For example, consider the system 2290 of FIG. 22 and the instructions 2296, which may include instructions of one or more of the CRM blocks 2211, 2221, 2231, and 2241.

As to CPT data of measurements referenced with respect to depth, the measurements can include, for example, one or more of cone measurements, pore pressure measurements, and friction measurements. As an example, measurements may include pore water pressure for one or more locations (e.g., u₁, u₂, u₃, etc.), shear wave velocity from seismic cone penetration (or penetrometer) test (sCPT), and/or one or more of other types of measurements (e.g., consider gamma CPT, etc.).

As an example, one or more machine learning techniques may be utilized to enhance process operations, a process operations environment, a communications framework, etc. As explained, various types of information can be generated via operations where such information may be utilized for training one or more types of machine learning models to generate one or more trained machine learning models, which may be deployed within one or more frameworks, environments, etc.

As to types of machine learning models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked autoencoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open-source software library for dataflow programming that includes a symbolic math library, which can be implemented for machine learning applications that can include neural networks. As an example, the CAFFE framework may be implemented, which is a DL framework developed by Berkeley AI Research (BAIR) (Berkeley, California). As another example, consider the SCIKIT framework (e.g., scikit-learn library, etc.), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device may utilize TENSORFLOW LITE (TFL) or another type of lightweight framework. TFL is a set of tools that enables on-device machine learning where models may run on mobile, embedded, and IoT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). Multiple platform support is available for TFL, covering ANDROID and iOS devices, embedded LINUX, and microcontrollers. Diverse language support is available for TFL, which includes JAVA, SWIFT, Objective-C, C++, and PYTHON. High performance support is available for TFL, with hardware acceleration and model optimization. Machine learning tasks using TFL may include, for example, image classification, object detection, pose estimation, question answering, text classification, etc., on multiple platforms.

As an example, computational equipment on a vehicle, a vessel, etc., may implement one or more types of frameworks. For example, consider a TFL framework implemented in combination with a CPT data handling framework for improving data quality for CPT data, optionally on site. In such an example, consider acquiring data, training and applying one or more ML models to data as they are acquired (e.g., consider real-time processing).

As an example, a method can include receiving cone penetrometer test data of measurements referenced with respect to depth in stratified material for a location at a site; processing the cone penetrometer test data using a machine learning model-based computational framework to identify one or more quality issues and to generate synthetic cone penetrometer test data at one or more depths; and outputting improved quality cone penetrometer data based at least in part on the generated synthetic cone penetrometer test data. In such an example, the measurements can include one or more of a friction measurement, a cone load measurement, and a pore pressure measurement. As explained, one or more other types of measurements can be included, additionally or alternatively.

As an example, a machine learning model-based computational framework can include at least one one-dimensional convolution neural network (1D-CNN) where, for example, a machine learning model-based computational framework includes one 1D-CNN per measurement type (e.g., friction, cone load, pore pressure, etc.). In such an example, the 1D-CNNs can be or can include filters, wherein each of the filters is applied to a respective one of the measurement types. In such an example, the machine learning model-based computational framework can include a U-Net architecture that includes a contracting path and an expansive path, wherein the contracting path receives output from the 1D-CNNs.

As an example, a method can include harmonizing cone penetrometer test data prior to processing (e.g., consider harmonizing as a type of preprocessing that may handle one or more of units, names, variable selection, and sampling rate control).

As an example, a method can include identifying non-natural data within cone penetrometer test data. For example, consider identifying that includes generating one or more cross-plots for two or more measurement types of the measurements.

As an example, a method can include detecting one or more quality issues using unsupervised clustering. As an example, a method can perform such detecting with reference to one or more maps, which may include regions, clusters, etc., for data of known quality (e.g., consider one or more reference maps, etc.).

As an example, a method can include generating a machine learning model of a computational framework. In such an example, the generating can include implementing a self-supervised learning technique. For example, consider generating that implements an augmentation technique to increase an amount of training data. In such an example, the augmentation technique can implement one or more of random distortions and systematic alterations to available cone penetrometer test data. As an example, a method can include generating that trains a machine learning model using cone penetrometer test data from multiple locations at a site. In such an example, the generating can generate a trained machine learning model that can be utilized for one or more purposes, which may include, for example, generating synthetic cone penetrometer test data (e.g., cone penetration data) at one or more locations, which can include, for example, one or more locations where a CPT has not been performed. As explained, a framework may be utilized for outputting information for locations, which may be, for example, locations to install equipment (e.g., wind turbines, etc.). Such information may include, for example, foundation specifications that account for physical properties of stratified subsurface material at a land location and/or at a marine location.

As an example, a method may include using a machine learning model-based computational framework that can include at least a trained encoder that generates representations of input in a reduced dimensionality space. In such an example, the trained encoder may be part of a denoising autoencoder or operatively coupled to a neural network model. As to a denoising autoencoder, it can include a trained encoder and a trained decoder. As to a neural network model, it may be trained to generate desirable output, which may include one or more types of logs, one or more types of indexes, etc.

As an example, a method may include outputting at least one soil type index value based at least in part on generated synthetic cone penetrometer test data. For example, consider outputting one or more of I_{SBT} and I_{C}; noting that one or more other types of indexes may be formulated, etc.

As an example, a method can include processing that includes comparing predicted cone penetrometer test data values to original cone penetrometer test data values to identify outliers. Such outliers may exist for one or more reasons, which can include one or more quality reasons (e.g., as associated with one or more anomalies at a location, one or more data acquisition issues, etc.).

As an example, a method can include processing that includes filtering cone penetrometer data to generate training data for a machine learning model of the framework. As explained, training data may be generated using one or more techniques, which may aim to increase data quality and/or to augment (e.g., supplement) an amount of training data.

As an example, a method can include using improved quality cone penetrometer test data to generate foundation information for wind energy production equipment such as, for example, onshore and/or offshore wind turbines. In such an example, the foundation information can provide for adequate operation of such equipment, which may account for loading, which can include wind loading, water/wave loading, etc., depending on where a foundation is to be located and specifications of equipment to be supported by the foundation (e.g., including operational specifications that may depend on weather, waves and/or other physical phenomena, etc.).

As an example, a system can include a processor; a memory accessible to the processor; processor-executable instructions stored in the memory and executable by the processor to instruct the system to: receive cone penetrometer test data of measurements referenced with respect to depth in stratified material for a location at a site; process the cone penetrometer test data using a machine learning model-based computational framework to identify one or more quality issues and to generate synthetic cone penetrometer test data at one or more depths; and output improved quality cone penetrometer data based at least in part on the generated synthetic cone penetrometer test data. As an example, such a system can be or include a cone penetrometer (or penetration) test (CPT) framework.

As an example, one or more computer-readable media can include computer-executable instructions executable by a system to instruct the system to: receive cone penetrometer test data of measurements referenced with respect to depth in stratified material for a location at a site; process the cone penetrometer test data using a machine learning model-based computational framework to identify one or more quality issues and to generate synthetic cone penetrometer test data at one or more depths; and output improved quality cone penetrometer data based at least in part on the generated synthetic cone penetrometer test data. As an example, such one or more computer-readable media can be executable to establish a cone penetrometer (or penetration) test (CPT) framework as a computational framework.

As an example, a computer program product can include one or more computer-readable storage media that can include processor-executable instructions to instruct a computing system to perform one or more methods and/or one or more portions of a method.

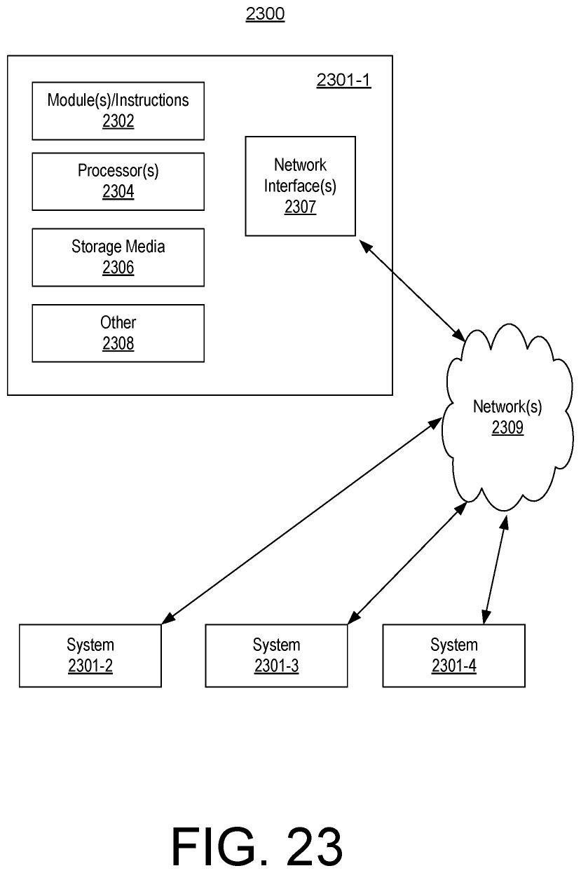

In some embodiments, a method or methods may be executed by a computing system. FIG. 23 shows an example of a system 2300 that can include one or more computing systems 2301-1, 2301-2, 2301-3 and 2301-4, which may be operatively coupled via one or more networks 2309, which may include wired and/or wireless networks.

As an example, a system can include an individual computer system or an arrangement of distributed computer systems. In the example of FIG. 23, the computer system 2301-1 can include one or more modules 2302, which may be or include processor-executable instructions, for example, executable to perform various tasks (e.g., receiving information, requesting information, processing information, simulation, outputting information, etc.).

As an example, a module may be executed independently, or in coordination with, one or more processors 2304, which is (or are) operatively coupled to one or more storage media 2306 (e.g., via wire, wirelessly, etc.). As an example, one or more of the one or more processors 2304 can be operatively coupled to at least one of one or more network interface 2307. In such an example, the computer system 2301-1 can transmit and/or receive information, for example, via the one or more networks 2309 (e.g., consider one or more of the Internet, a private network, a cellular network, a satellite network, etc.). As shown, one or more other components 2308 can be included.

As an example, the computer system 2301-1 may receive from and/or transmit information to one or more other devices, which may be or include, for example, one or more of the computer systems 2301-2, etc. A device may be located in a physical location that differs from that of the computer system 2301-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 2306 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, a memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

### DOCUMENTS INCORPORATED BY REFERENCE HEREIN IN THEIR ENTIRETY

[1] Lunne, T., “The CPT in offshore soil investigations—a historic perspective”. Paper presented at the 2nd International Symposium on Cone Penetration Testing, Huntington Beach, CA, USA, May 2010.
[2] Robertson, P. K., “Interpretation of cone penetration tests—a unified approach”. Paper published by NRC Research Press, doi:10.1139/T09-065, 2009.
[3] Simoes, Vanessa, Maniar, Hiren, Abubakar, Aria, and Tao Zhao. “Deep Learning for Multiwell Automatic Log Correction.” Petrophysics 63 (2022): 724-747.
[4] Simoes, V., Maniar, H., Zhao, T, Abubakar, A., and Akkurt, R., “A Comparative Study for Machine-Learning-Based Methods for Log Prediction”; Paper presented at the SPWLA 63rd Annual Logging Symposium, Stavanger, Norway, June 2022.
[5] Jacob Devlin, Ming-Wei Chang, Kenton Lee, and Kristina Toutanova, “BERT: Pre-training of Deep Bidirectional Transformers for Language Understanding”; In Proceedings of the 2019 Conference of the North American Chapter of the Association for Computational Linguistics: Human Language Technologies, Volume 1 (Long and Short Papers), pages 4171-4186, Minneapolis, Minnesota. Association for Computational Linguistics.
[6] Simoes, Vanessa, Maniar, Hiren, Abubakar, Aria, and Tao Zhao. “Deep Learning for Multiwell Automatic Log Correction.” Paper presented at the SPWLA 63rd Annual Logging Symposium, Stavanger, Norway, June 2022.
[7] Ahmadi, M. M. and Robertson P. K., “Thin-layer effects on the CPT qc measurement”, Volume 42, pages 1302-1317, Canadian Geotechnical Journal, 2011.
[8] Lunne, T., “Importance of CPT in development of offshore windfarms”, 14 Jun. 2016: www2.ing.unipi.it/geotecnica/05_Eventi/Pres_Lunne.pdf.
[9] USDA, Natural Resources Conservation Services (NRCS), Part 631 Geology, National Engineering Handbook, Chapter 11: Cone Penetrometer (210-VI-NEH, Amend. 55, January 2012).

What is claimed is:

1. A method comprising:
receiving cone penetrometer test data of measurements referenced with respect to depth in stratified material for a location at a site;
processing the cone penetrometer test data using a machine learning model-based computational framework to identify one or more quality issues and to generate synthetic cone penetrometer test data at one or more depths; and
outputting improved quality cone penetrometer data based at least in part on the generated synthetic cone penetrometer test data.

2. The method of claim 1, wherein the measurements comprise one or more of a friction measurement, a cone load measurement, and a pore pressure measurement.

3. The method of claim 1, wherein the machine learning model-based computational framework comprises at least one one-dimensional convolution neural network (1D-CNN).

4. The method of claim 3, wherein the machine learning model-based computational framework comprises one 1 D-CNN per measurement type.

5. The method of claim 4, wherein the 1D-CNNs comprise filters, wherein each of the filters is applied to a respective one of the measurement types.

6. The method of claim 5, wherein the machine learning model-based computational framework comprises a U-Net architecture that comprises a contracting path and an expansive path, wherein the contracting path receives output from the 1D-CNNs.

7. The method of claim 1, comprising harmonizing the cone penetrometer test data prior to the processing.

8. The method of claim 1, comprising identifying non-natural data within the cone penetrometer test data.

9. The method of claim 8, wherein the identifying comprises generating one or more cross-plots for two or more measurement types of the measurements

10. The method of claim 1, comprising detecting one or more of the quality issues using unsupervised clustering.

11. The method of claim 1, comprising generating a machine learning model of the computational framework.

12. The method of claim 11, wherein the generating implements a self-supervised learning technique.

13. The method of claim 12, wherein the generating implements an augmentation technique to increase an amount of training data, wherein the augmentation technique implements one or more of random distortions and systematic alterations to available cone penetrometer test data.

14. The method of claim 11, wherein the generating trains the machine learning model using cone penetrometer test data from multiple locations at the site.

15. The method of claim 1, wherein the machine learning model-based computational framework comprises at least a trained encoder that generates representations of input in a reduced dimensionality space, wherein the trained encoder is part of a denoising autoencoder or operatively coupled to a neural network model.

16. The method of claim 1, further comprising outputting at least one soil type index value based at least in part on the generated synthetic cone penetrometer test data.

17. The method of claim 1, wherein the processing comprises filtering the cone penetrometer data to generate training data for a machine learning model of the framework.

18. The method of claim 1, further comprising using the improved quality cone penetrometer test data to generate foundation information for wind energy production equipment.

19. A system comprising:
a processor;
a memory accessible to the processor;
processor-executable instructions stored in the memory and executable by the processor to instruct the system to:
receive cone penetrometer test data of measurements referenced with respect to depth in stratified material for a location at a site;
process the cone penetrometer test data using a machine learning model-based computational framework to identify one or more quality issues and to generate synthetic cone penetrometer test data at one or more depths; and
output improved quality cone penetrometer data based at least in part on the generated synthetic cone penetrometer test data.

20. One or more computer-readable media comprising computer-executable instructions executable by a system to instruct the system to:
receive cone penetrometer test data of measurements referenced with respect to depth in stratified material for a location at a site;
process the cone penetrometer test data using a machine learning model-based computational framework to identify one or more quality issues and to generate synthetic cone penetrometer test data at one or more depths; and
output improved quality cone penetrometer data based at least in part on the generated synthetic cone penetrometer test data.
